(19) United States
(12) Patent Application Publication
(10) Pub. No.: US 2017/0016755 A1
(43) Pub. Date: Jan. 19, 2017

(54) Method of Determining a Flow Rate and Related Apparatus

(71) Applicant: Delphi International Openrations Luxembourg S.A.R.L., Bascharage (LU)

(72) Inventors: Nicolas Boussange, Villebarou (FR); Christophe Lallemant, Gillingham (GB)

(21) Appl. No.: 15/300,882

(22) PCT Filed: Mar. 25, 2015
(86) PCT No.: PCT/EP2015/056342

§ 371 Date: Sep. 30, 2016

(30) Foreign Application Priority Data
Apr. 2, 2014 (GB) 1405881.2

(51) Int. Cl. G01F 25/00; G01F 1/00

(52) U.S. Cl. CPC G01F 25/0038; G01F 1/007

(57) ABSTRACT

A method of determining a flow rate of a liquid includes collecting the liquid in a container; monitoring the collection of liquid in the container with respect to time; and determining a first value of the flow rate based on the monitored collection of liquid in the container with respect to time. An apparatus for determining a flow rate of a liquid is also provided.

### CROSS REFERENCE TO RELATED APPLICATIONS

This application is a national stage application under 35 USC 371 of PCT Application No. PCT/EP2015/056342 having an international filing date of Mar. 25, 2015, which is designated in the United States and which claimed the benefit of GB Patent Application No. 1405881.2 filed on Apr. 2, 2014 the entire disclosures of each are hereby incorporated by reference in their entirety.

### TECHNICAL FIELD

The present disclosure relates to a method of determining a flow rate and to an apparatus for implementing such a method.

### BACKGROUND

A flow meter is used to measure the flow rate of a fluid, for example the flow of liquid through a conduit. It is generally recognized that measuring flow rates accurately is difficult. Various flow meters already exist in the prior art, such as mechanical flow meters, pressure-based flow meters, optical flow meters, or coriolis flow meters. These flow meters may be inaccurate, and generally need to be calibrated.

Various systems are used to calibrate flow meters. One such known system is represented in FIG. 1. The system 1 comprises a container 3 positioned on a weighing device 5, and a three-way valve 7 for controlling the supply of liquid to the container 3. The three-way valve 7 is controlled by a valve control unit 9. A flow meter 11 to be tested is disposed upstream of the three-way valve 7 and the container 3. In operation, liquid flows from a flow generator 13 through the flow meter 11. The flow meter 11 is configured to measure a flow rate of the liquid and to deliver a predetermined quantity of liquid to the container 3. The valve control unit 9 opens the three-way valve 7 to allow the liquid to flow through the flow meter 11 and into the container 3. The three-way valve 7 remains open for a predetermined time, corresponding to the time needed to distribute the predetermined quantity of liquid to the container 3. The valve control unit 9 then closes the three-way valve 7. At the end of said predetermined time, the liquid collected in the container 3 is weighed by the weighing device 5. The mass of liquid collected can be used to calculate an average flow rate over the predetermined time, which is then compared to the flow rate measured by the tested flow meter 11. The flow meter 11 is calibrated based on the average flow rate.

However, this system requires the operation of a relatively high number of components, which may introduce errors in the measurement. For example, the three-way valve 7 can leak and distort the mass of liquid collected in the container 3. Moreover, the valve control unit 9 can send control signals to the three-way valve 7 with a delay, which may introduce uncertainty on the time during which the method is implemented, and thereby to the calculated average flow rate. Furthermore, the weighing device 5, and the program which runs the calibration process may introduce errors. This may present a particular problem as the total amount of errors introduced by the components of the system may be higher than the difference between the measured flow rate and the calculated average flow rate, which renders the system unreliable. Moreover, an operator may have to be present during the operation of the system to start the measurement, read the mass displayed by the weighing device 5, and regularly empty the container 3.

At least in certain embodiments, the present invention sets out to overcome or ameliorate at least some of the problems associated with known systems.

### SUMMARY OF THE INVENTION

Aspects of the present invention relate to a method of determining a flow rate and to an apparatus for implementing such a method.

According to a further aspect of the present invention there is provided a method of determining a flow rate of a liquid, the method comprising: collecting the liquid in a container; monitoring the collection of liquid in the container with respect to time; determining a first value of the flow rate based on the monitored collection of liquid in the container with respect to time; and automatically draining the liquid collected from the container. The method can comprise repeating the collection of liquid in said container and the subsequent draining of the liquid collected from the container. Thus, the method can comprise repeating a collection/draining cycle. This cycle can be repeated indefinitely without interrupting the determination of the first value of the flow rate. It will be appreciated therefore that the method can be performed continuously.

The method can comprise repeatedly draining the liquid collected from the container. In certain embodiments, the method can comprise providing a continuous supply of liquid to the container. The method can comprise periodically draining the collected liquid from the container. By periodically draining the liquid collected, the supply of liquid can continue uninterrupted without the container overflowing. At least in certain embodiments, the method can be performed continuously by automatically draining the container.

The method can comprise determining an instantaneous flow rate by monitoring collection of liquid in the container with respect to time. The first flow rate value can be an instantaneous flow rate.

According to a further aspect of the present invention, there is provided a method of determining a flow rate of a liquid, the method comprising: collecting the liquid in a container; monitoring the collection of liquid in the container with respect to time; and determining a first value of the flow rate based on the monitored collection of liquid in the container with respect to time. The collection of liquid is monitored with respect to time and, at least in certain embodiments, the method can be performed with fewer components which may introduce errors. Also, at least in certain embodiments, the method does not require a high involvement of an operator, or can be implemented without an operator being present. The method can provide an efficient and reliable technique for determining flow rate.

The method can comprise using a flow meter to determine a second value of the flow rate of liquid. The second flow rate value can be a second instantaneous flow rate. The flow meter and the container can be arranged in series. The liquid can be collected in the container after it has flowed through said flow meter. The method can comprise calibrating the flow meter based on a comparison of the first flow rate value to the second flow rate value. A difference can be identified between the first flow rate value and the second flow rate value. The collection of the liquid in the container can be monitored throughout a measurement cycle.

The first flow rate value and the second flow rate value can both be instantaneous flow rates. The method can comprise determining said first flow rate value and said second flow rate value at least substantially simultaneously. The method can comprise comparing first and second instantaneous flow rate values at any given time. The comparison can be performed at least substantially in real time.

It will be appreciated that the first and second flow rate values relate to the flow of liquid through the flow meter at any given time: the first flow rate value is the flow rate determined by monitoring the liquid collected in the container and the second flow rate value is the flow rate measured by the flow meter. The comparison of the first and second flow rate values can identify a difference. The method can comprise calibrating the flow meter based on the difference between the first flow rate value and the second flow rate value.

A flow generator can be provided to generate the flow of liquid. The method can comprise controlling the flow generator to supply a steady-state flow, or a variable flow. The flow generator can, for example, be a fuel injector. The fuel injector can be of the type for injecting fuel into a combustion chamber of an internal combustion engine. The fuel injector can be controlled to generate a pulsed flow of liquid.

Monitoring the collection of liquid in the container can comprise determining the mass of liquid collected in the container with respect to time. Determining the mass of liquid collected in the container can comprise measuring the mass of liquid collected in the container with respect to time, for example using a weighing scale. The mass of liquid could also be determined by measuring the pressure of the liquid in the container or the volume of liquid collected in the container during a measurement cycle. Determining the first value of the flow rate can comprise calculating the derivative of the determined mass of collected liquid with respect to time. By calculating the derivative of the determined mass with respect to time, the first value of the flow rate of liquid can be determined. The first value of the flow rate can represent an instantaneous flow rate of liquid.

Monitoring the collection of liquid in the container can comprise measuring the pressure of liquid collected in the container with respect to time. Determining the first value of the flow rate can comprise calculating the derivative of the determined pressure of collected liquid with respect to time.

Monitoring the collection of liquid in the container can comprise measuring the volume of liquid collected in the container with respect to time. Determining the first value of the flow rate can comprise calculating the derivative of the determined volume of collected liquid with respect to time.

The method comprises draining the liquid collected from the container. The liquid collected in the container is automatically drained from the container. Draining the liquid collected from the container can be implemented at predetermined time intervals or when a predetermined quantity of liquid has collected in the container. Draining the liquid collected from the container can be performed using a siphon to drain the liquid collected from the container or using valve means to drain the liquid collected from the container. The siphon can be an automatic siphon. In a variant, the siphon can be an automatic priming siphon. The valve means can be electromechanical, for example a solenoid valve. A pump could be used to drain the container.

The method can be used to determine the flow rate of the liquid through a conduit.

The first flow rate value can represent a first flow rate magnitude; and the second flow rate value can represent a second flow rate magnitude. The flow rate can be determined as a mass flow rate or as a volumetric flow rate.

According to a further aspect of the present invention there is provided an apparatus for determining a flow rate of a liquid, the apparatus comprising: a container for collecting the liquid; means for monitoring the collection of liquid in the container with respect to time; processing means configured to determine a first value of the flow rate based on the monitoring of the collection of liquid in the container with respect to time; and draining means for automatically draining liquid from the container. The apparatus can be configured repeatedly to collect liquid in the container and then to drain the liquid collected from the container. The operation of the draining means automatically to drain the collected liquid can enable repetition of this cycle. At least in certain embodiments the apparatus can operate continuously.

The apparatus can be configured repeatedly to drain the liquid collected from the container. In certain embodiments, the apparatus can be configured to provide a substantially continuous supply of liquid to the container. In use, the apparatus periodically drains the collected liquid from the container. By periodically draining the liquid collected, the supply of liquid can continue uninterrupted without the container overflowing. At least in certain embodiments, the apparatus can operate continuously by automatically draining the container.

The processing means can be configured to determine an instantaneous flow rate by monitoring of the collection of liquid in the container with respect to time. The first flow rate value can be a first instantaneous flow rate.

According to a yet further aspect of the present invention there is provided an apparatus for determining a flow rate of a liquid, the apparatus comprising a container for collecting the liquid; means for monitoring the collection of liquid in the container with respect to time; and processing means configured to determine a first value of the flow rate based on the monitoring of the collection of liquid in the container with respect to time. The apparatus can be used to determine a flow rate of a liquid through a conduit. The container can be configured to collect the liquid after it has flowed through the conduit.

The processing means can be configured to test a flow meter, said flow meter being adapted to determine a second value of the flow rate of liquid. The flow meter and the container can be arranged in series. In use, the liquid can be collected in the container after flowing through said flow meter. This arrangement enables the first and second flow rate values to be determined at least substantially simultaneously. The processing means can be configured to perform a comparison of said first and second flow rate values. The processing means can determine a difference between said first and second flow rate values based on said comparison. The processing means can be configured to calibrate said flow meter based on the comparison of the first flow rate value to the second flow rate value. The processing means can comprise at least one processor.

The second flow rate value can be a second instantaneous flow rate. The first flow rate value and the second flow rate value can both be instantaneous flow rates. The first and second instantaneous flow rates can be compared directly with each other at any given time. The processing means can be configured to perform the comparison of said first and second instantaneous flow rates at least substantially in real time.

The apparatus can comprise a flow generator. Alternatively, the apparatus can be connected downstream of a flow generator. The flow generator can be configured to generate a flow of liquid through the flow meter. The flow generator can be configured to generate a steady-state flow or a variable flow. The flow generator can, for example, be a fuel injector. The fuel injector can be of the type for injecting fuel into a combustion chamber of an internal combustion engine. The fuel injector can be controlled to generate a pulsed flow of liquid, whose flow rate is then measured by the flow meter.

The monitoring means can comprise means for determining the mass of liquid collected in the container with respect to time. The mass of liquid collected in the container can be measured by weighing scales. The processing means can be configured to calculate the derivative of the determined mass of collected liquid in the container with respect to time. The calculated flow rate can be an instantaneous flow rate of liquid.

Alternatively, the mass of liquid collected in the container could be determined by measuring the pressure or volume of the liquid collected in the container.

The monitoring means can comprise means for determining the pressure of the liquid collected in the container with respect to time. The processing means can be configured to calculate the derivative of the determined pressure of the collected liquid in the container with respect to time.

The monitoring means can comprise means for determining the volume of the liquid collected in the container with respect to time. The processing means can be configured to calculate the derivative of the determined volume of the collected liquid in the container with respect to time.

The apparatus comprises draining means for draining the liquid from the container. The draining means is configured automatically to drain liquid from the container. The draining means can allow the apparatus to work continuously. The draining means can be controlled in dependence on the determined flow rate. The draining means can comprise a siphon. The siphon can be an automatic siphon. In a variant, the siphon can be an automatic priming siphon. Alternatively, the draining means can comprise a pump or a valve, such as a solenoid valve. The draining means can be in the form of an automated drainage device.

The processing means can be configured to control operation of the flow generator and/or the draining means. The processing means can be configured to provide partially or completely automated operation of the apparatus.

The processing means referenced herein may suitably comprise a control unit or a computational device having one or more electronic processors. Thus the apparatus may comprise a single control unit or electronic controller or alternatively different functions of the controller may be embodied in, or hosted in, different control units or controllers. As used herein the term “controller” or “control unit” will be understood to include both a single control unit or controller and a plurality of control units or controllers collectively operating to provide any stated control functionality. To configure a controller, a suitable set of instructions may be provided which, when executed, cause said control unit or computational device to implement the control techniques specified herein. The set of instructions may suitably be embedded in said one or more electronic processors. Alternatively, the set of instructions may be provided as software saved on one or more memory associated with said controller to be executed on said computational device. A first controller may be implemented in software run on one or more processors. One or more other controllers may be implemented in software run on one or more processors, optionally the same one or more processors as the first controller. Other suitable arrangements may also be used.

Within the scope of this application it is expressly intended that the various aspects, embodiments, examples and alternatives set out in the preceding paragraphs, in the claims and/or in the following description and drawings, and in particular the individual features thereof, may be taken independently or in any combination. Features described in connection with one embodiment are applicable to all embodiments, unless such features are incompatible.

### BRIEF DESCRIPTION OF THE DRAWINGS

One or more embodiments of the present invention will now be described, by way of example only, with reference to the accompanying Figures, in which:

FIG. 1 shows a schematic view of a prior art system for calibrating a flow meter;

FIG. 2 shows a schematic view of an apparatus for calibrating a flow meter in accordance with an embodiment of the present invention;

FIG. 3 shows a graph representing the mass of liquid determined with respect to time with the apparatus shown in FIG. 2, in the case of a pulsed flow;

FIG. 4 shows a graph representing the mass of liquid determined with respect to time with the apparatus shown in FIG. 2, in the case of a continuous (i.e. uninterrupted) flow;

FIG. 5 shows a graph representing the first and second flow rate values determined with the apparatus shown in FIG. 2 during a calibration process of a flow meter, and the difference between the first and second determined flow rate values;

FIG. 6 shows a schematic view of a draining means of the apparatus in accordance with a first variant of the present invention;

FIG. 7 shows a graph representing the mass of liquid determined with respect to time with the apparatus according to the first variant of the present invention;

FIG. 8 shows a schematic view of a draining means of the apparatus in accordance with a second variant of the present invention;

FIG. 9 shows a graph representing the mass of liquid determined with respect to time with the apparatus according to the second variant of the present invention; and

FIG. 10 shows a schematic view of means for measuring the pressure in the container with respect to time according to an embodiment of the present invention.

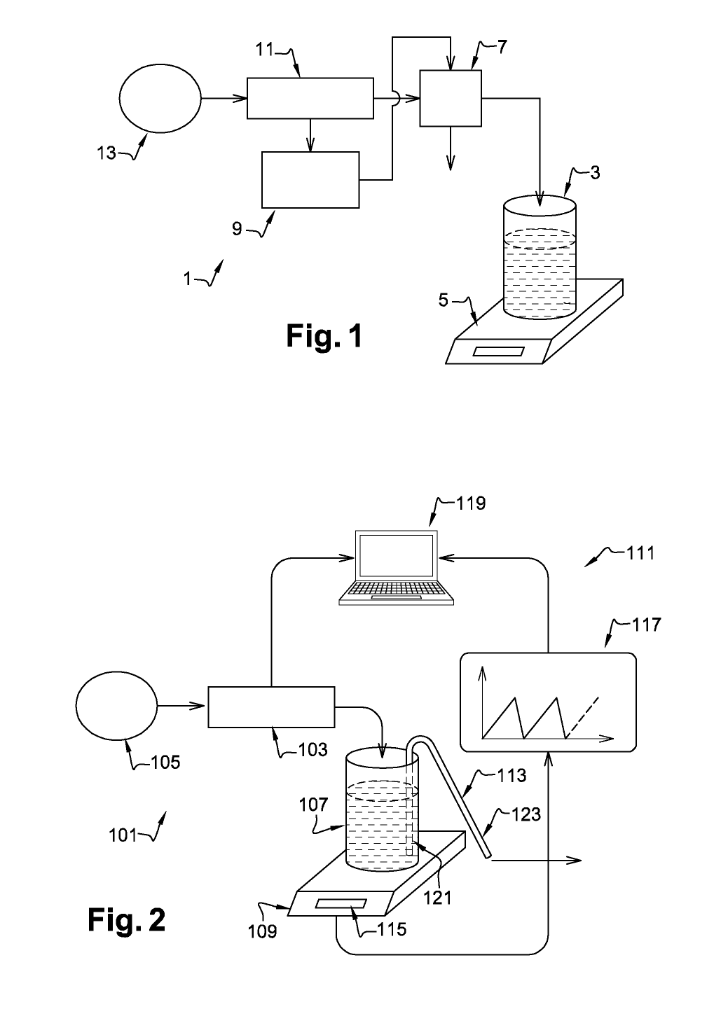

### DETAILED DESCRIPTION

An apparatus 101 for determining a flow rate of a liquid in accordance with an embodiment of the present invention will now be described with reference to the accompanying Figures, and in particular with reference to FIGS. 2 to 10.

The apparatus 101 is configured to determine a flow rate of a liquid. At least in certain embodiments, the apparatus 101 can be used to test the accuracy of a flow meter 103, and can be used to calibrate said flow meter 103. The flow meter 103 is disposed downstream of a flow generator 105 and the apparatus 101 is configured to determine the flow rate of liquid through the flow meter 103. In use, the flow meter 103 generates a signal representative of a measured flow rate therethrough.

The flow generated by the flow generator 105 can be either a pulsed flow or a continuous (i.e. uninterrupted) flow. The flow rate can be steady-state or variable with time (i.e. increase or decrease). In the present embodiment, the flow generator 105 is a fuel injector for delivering fuel to an internal combustion engine (not shown), particularly a compression ignition combustion engine. The fuel injector is operable to generate a pulsed flow representative of a series of fuel injection cycles.

With reference to FIG. 2, the apparatus 101 comprises a container 107 for collecting liquid after it has flowed through the flow meter 103, monitoring means 109 for monitoring the collection of liquid in the container 107 with respect to time, and processing means 111 for calculating the liquid flow rate based on the monitored collection of liquid in the container 107 with respect to time. The apparatus 101 further comprises means 113 for draining liquid from the container 107. The apparatus 101 is connected downstream of the flow meter 103. The flow generator 105, the flow meter 103 and the container 107 are in fluid communication with each other. The container 107 is a beaker in the illustrated arrangement, but it will be appreciated that other types of container could be used.

The monitoring means 109 is configured to measure the mass of liquid collected in the container 107 with respect to time. The monitoring means 109 in the present embodiment is in the form of an electronic weighing scale 109 configured to continuously measure the mass of liquid collected in the container 107. The measured mass can optionally be output in real-time to a display screen 115. In use, the electronic weighing scale 109 measures the mass of the liquid collected in the container 107 throughout a measurement cycle. The electronic weighing scale 109 generates time-related (temporal) mass data which is transmitted to the processing means 111 as a signal. The time-related mass data is represented schematically as a saw-tooth signal in FIG. 2, but it will be appreciated that the form of the signal will depend on the characteristics of the flow generated by the flow generator 105. The electronic weighing scale 109 can have a relatively high precision, for example 1 milligram, to enable a relatively short measurement cycle. Alternatively, a relatively long measurement cycle can be implemented with a relatively low precision electronic weighing scale 109, for example having a precision of 1 gram.

The processing means 111 is configured to calculate a first value of the liquid flow rate based on the measured mass of the liquid collected in the container 107 with respect to time. The processing means 111 comprises a receiver 117 and at least one processor 119 (only one of which will be described herein). The receiver 117 is coupled to the electronic weighing scale 109, and is adapted to record the measurement of the mass of collected liquid in the container 107 with respect to time. The processor 119 receives the time-related mass data and is configured to calculate a first value of the liquid flow rate by calculating the derivative of the measured mass of the liquid collected in the container 107 with respect to time. The processor 119 can thereby determine an instantaneous flow rate of the liquid. Thus, the flow rate of the liquid can be determined at any given time.

The processor 119 is also coupled to the flow meter 103 to receive a signal from the flow meter 103. The processor 119 calculates a second value of the flow rate based on the signal received from the flow meter 103.

The processor 119 calculates the difference between the first flow rate value and the second flow rate value. The processor 119 can generate a calibration factor based on this difference which can be used to calibrate the flow meter 103.

The draining means is in the form of a siphon 113 in the present embodiment. The siphon 113 comprises a liquid inlet 121 and a liquid outlet 123. The liquid inlet 121 is disposed within the container 107. The liquid outlet 123 is disposed outside the container 107 and is in fluid communication with a reservoir (not shown) for collecting the liquid. The siphon 113 drains the liquid collected in the container 107 when the liquid reaches a predetermined threshold.

A method of using the apparatus 101 to determine a flow rate of a liquid and to calibrate a flow meter 103 in accordance with an embodiment of the present invention will now be explained in detail with reference to FIGS. 2 to 10.

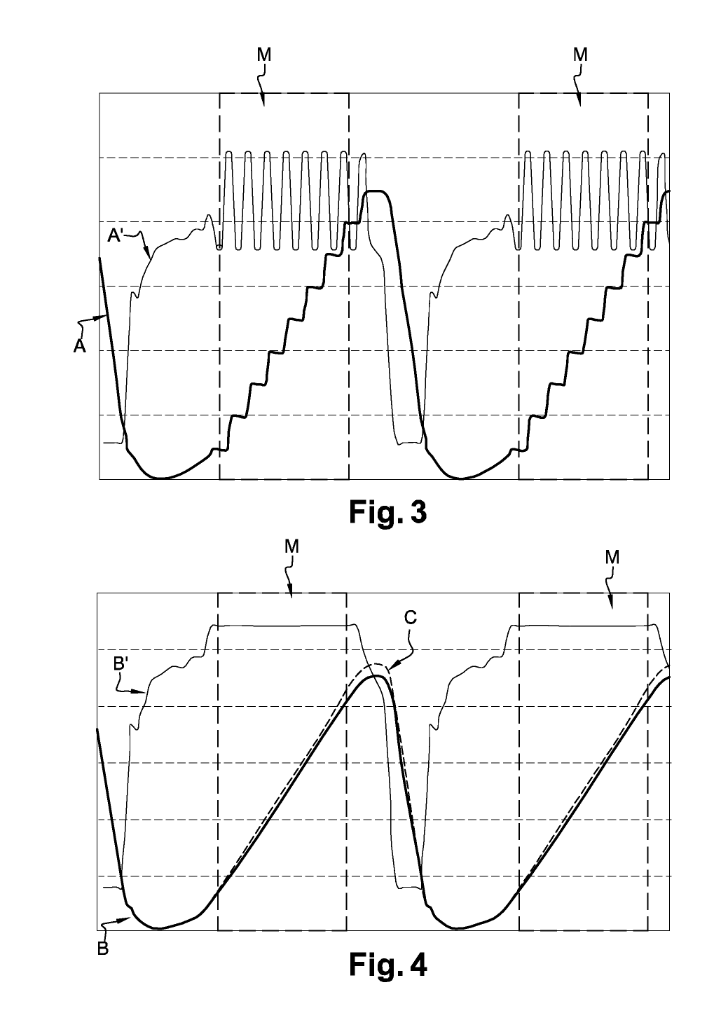

During a measurement cycle, liquid flows from the flow generator 105 through the flow meter 103. The flow meter 103 measures the flow rate of the liquid through the flow meter 103 and the measured flow rate is recorded by the processor 119. The liquid is collected in the container 107. Throughout the measurement cycle, the electronic weighing scale 109 continuously measures the mass of fluid collected in the container 107. The measured mass is recorded by the receiver 117. Once the mass of collected fluid reaches a predetermined value, the siphon 113 drains the collected fluid from the container 107 (for example to a reservoir). The mass measured with respect to time by the apparatus 101 is represented by the curves A and B in FIGS. 3 and 4, respectively for a pulsed flow and a continuous flow. The processor 119 selects measurement time regions M corresponding to the time during which liquid is collected in the container 107, i.e. corresponding to the or each measurement cycle. The selection of the measurement time regions M is based on a measured minimum mass of liquid in the container 107. In a variant, the measurement time regions M are determined by the profile of the measured curve. In these regions, the processor 119 calculates the derivative of the mass of collected liquid with respect to time. The calculated derivatives are represented by the curves A′ and B′ in FIGS. 3 and 4, respectively for a pulsed flow and a continuous flow. A correction factor can be introduced to take into account the force of the liquid acting on the apparatus. The correction factor can be dependent on the calculated flow rate. The correction factor can be determined empirically. The corrected mass is represented by the curve C in FIG. 4.

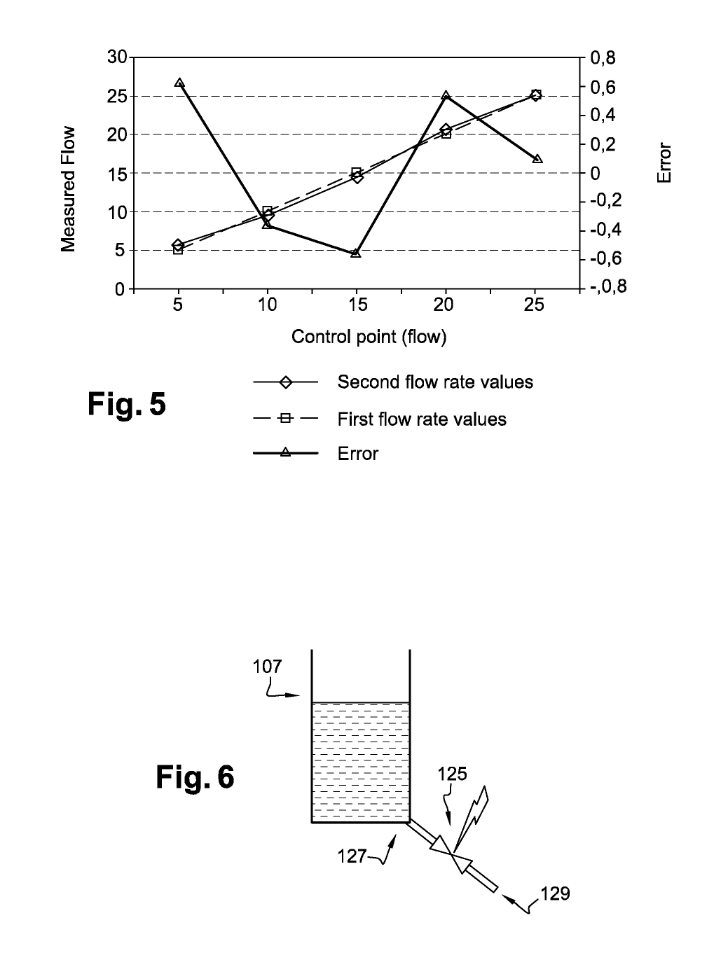

The processor 119 calculates a first flow rate value based on the measurement of the mass of liquid collected in the container 107. The processor 119 calculates a second flow rate value based on the signal output from the flow meter 103. A comparison is then made of said first and second flow rate values to determine a difference therebetween. The flow meter 103 is then calibrated based on the difference between the first flow rate value and the second flow rate value. The siphon 113 is used to drain the container 107. FIG. 5 shows the first flow rate values (represented by squares) and the second flow rate values (represented by diamonds) determined during the calibration process of the flow meter 103, and the difference between the first and second determined flow rate values (represented by triangles).

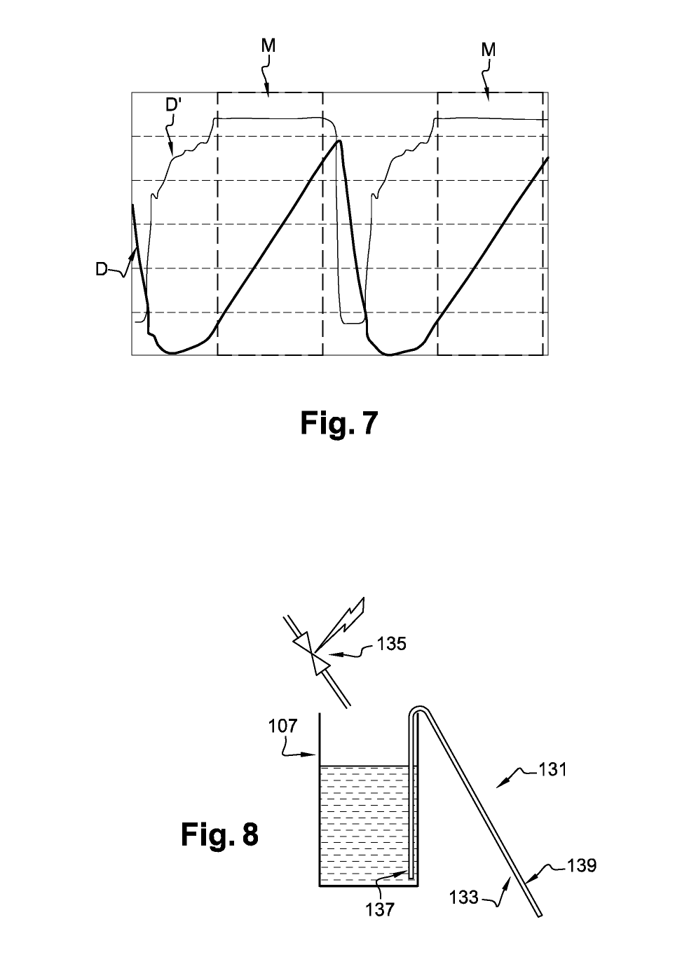

Variants of the draining means are described with reference to FIGS. 6 to 9. A first variant is illustrated in FIGS. 6 and 7. FIG. 6 shows draining means in the form of a solenoid valve 125 disposed in a drainage line. The solenoid valve 125 comprises a liquid inlet 127 and a liquid outlet 129. The liquid inlet 127 is connected to the container 107, and the liquid outlet 129 is in fluid communication with the reservoir. This arrangement is an alternative to the siphon 113 described herein. FIG. 7 shows a graph representing the mass of liquid measured with respect to time with the solenoid valve 125 (curve D), and the corresponding derivative with respect to time (curve D′).

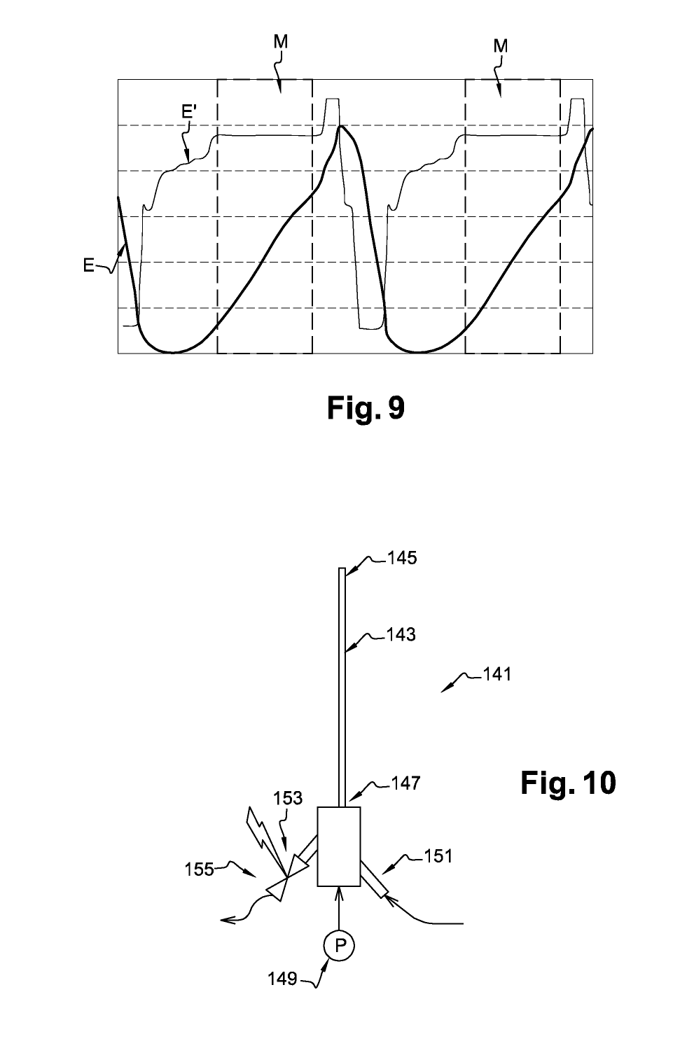

A second variant is illustrated in FIGS. 8 and 9. As shown in FIG. 8, the draining means is in the form of an automatic priming siphon 131. The automatic priming siphon 131 can be used when a low flow rate is to be determined by the apparatus 101. (The siphon 113 described in the previous embodiment may not be able to drain the container 107 automatically due to the low flow rate.) The automatic priming siphon 131 comprises a siphon portion 133 and an additional source of liquid 135 connected to the siphon portion 133 for priming the draining of liquid in the siphon portion 133. The siphon portion 133 comprises a liquid inlet 137 and a liquid outlet 139. The liquid inlet 137 is disposed in the container 107, and the liquid outlet 139 is in fluid communication with the reservoir (not shown). FIG. 9 shows a graph representing the mass of liquid measured with respect to time with the automatic priming siphon 131 (curve E), and the corresponding derivative with respect to time (curve E′).

An alternative monitoring means 141 is represented in FIG. 10. The monitoring means 141 is configured to measure the pressure of a liquid collected in a vertical column 143 connected to the flow meter 103. The pressure is then used to determine the mass of liquid collected in the container 107. The vertical column 143 comprises an upper end 145 and a lower end 147. The upper end 145 is open to atmosphere. Means for measuring the pressure in the vertical column 143 is connected to the lower end 147 of the vertical column 143. The means for measuring the pressure in the vertical column 143 is for example in the form of a pressure sensor 149. The vertical column 143 comprises a liquid inlet 151 and a liquid outlet 153. The liquid inlet 151 is intended to receive liquid from the flow meter 103. A draining means such as a solenoid valve 155 as described above is disposed at the liquid outlet 153 to drain the liquid from the vertical column 143. The arrows shown in FIG. 10 represent the liquid flow. In operation, liquid flows from the flow meter 103 to the vertical column 143, through the liquid inlet 151. At the same time, the pressure sensor 149 measures the pressure within the vertical column 143, while the liquid is flowing into the vertical column 143. The pressure is measured with respect to time. As the pressure in the vertical column 143 is proportional to the mass of liquid in the vertical column 143, the flow rate can be deduced from the measurement of the pressure with respect to time.

It will be appreciated that various changes and modifications can be made to the apparatus 101 described herein without departing from the scope of the present invention, as set out in the appended claims. For example, the electronic weighing scale 109 has been described as continuously measuring the mass of fluid collected in the container 107. In a modified arrangement, the electronic weighing scale 109 could be configured to measure the mass of the collected liquid intermittently, for example to take a measurement at predefined time intervals, such as 0.1 seconds.

The apparatus 101 described herein is configured to determine the flow rate of a liquid, but it will be appreciated that the apparatus 101 could be modified to determine the flow rate of a gas. Also, rather than monitor the collection of fluid in a container, the method could comprise monitoring the fluid in a reservoir provided upstream of the flow generator.

1. A method of determining a flow rate of a liquid, the method comprising:
collecting the liquid in a container;
monitoring the collection of liquid in the container with respect to time;
determining a first value of the flow rate based on the monitored collection of liquid in the container with respect to time; and
automatically draining the liquid collected from the container.

2. A method as claimed in claim 1 comprising providing a substantially continuous supply of liquid to the container and repeatedly draining the liquid collected from the container.

3. A method as claimed in claim 1, comprising using a flow meter to determine a second value of the flow rate, the method comprising calibrating the flow meter based on a comparison of the first flow rate value to the second flow rate value.

4. A method as claimed in claim 1, wherein monitoring the collection of liquid in the container comprises determining the mass of liquid collected in the container with respect to time.

5. A method as claimed in claim 1, wherein determining the first flow rate value comprises calculating the derivative of the determined mass of collected liquid with respect to time.

6. A method as claimed in claim 1, wherein monitoring the collection of liquid in the container comprises measuring the pressure of the liquid collected in the container with respect to time.

7. A method as claimed in claim 6, wherein determining the first flow rate value comprises calculating the derivative of the measured pressure of the liquid collected in the container with respect to time.

8. A method as claimed in claim 1, wherein the liquid is drained from the container when a predetermined quantity of liquid has collected in the container.

9. An apparatus for determining a flow rate of a liquid, the apparatus comprising:
a container for collecting the liquid;
means for monitoring the collection of liquid in the container with respect to time;
processing means configured to determine a first value of the flow rate based on the monitoring of the collection of liquid in the container with respect to time; and
draining means for automatically draining liquid from the container.

10. An apparatus as claimed in claim 9, wherein the apparatus is configured to provide a substantially continuous supply of liquid to the container and repeatedly to drain the liquid collected from the container.

11. An apparatus as claimed in claim 9, wherein the processing means is configured to calibrate a flow meter, said flow meter being adapted to determine a second value of the flow rate, wherein the processing means is configured to calibrate said flow meter based on a comparison of the first flow rate value to the second flow rate value.

12. An apparatus as claimed in claim 10, wherein the monitoring means comprises means for determining the mass of liquid collected in the container.

13. An apparatus as claimed in claim 12, wherein the processing means is configured to calculate the derivative of the determined mass of the collected liquid in the container with respect to time to determine the first flow rate value.

14. An apparatus as claimed in claim 9, wherein the monitoring means comprises means for measuring the pressure of the liquid collected in the container.

15. An apparatus as claimed in claim 14, wherein the processing means is configured to calculate the derivative of the determined pressure of the collected liquid in the container with respect to time to determine the first flow rate value.

16. An apparatus as claimed in claim 9, wherein the draining means is configured to drain the liquid from the container when a predetermined quantity of liquid has collected in the container.

17. An apparatus as claimed in claim 14, wherein the draining means comprises a siphon or a solenoid valve.

18. A method as claimed in claim 2, comprising using a flow meter to determine a second value of the flow rate, the method comprising calibrating the flow meter based on a comparison of the first flow rate value to the second flow rate value.

19. A method as claimed in claim 18, wherein the liquid is drained from the container when a predetermined quantity of liquid has collected in the container.

20. An apparatus as claimed in claim 10, wherein the processing means is configured to calibrate a flow meter, said flow meter being adapted to determine a second value of the flow rate, wherein the processing means is configured to calibrate said flow meter based on a comparison of the first flow rate value to the second flow rate value.
